(19) United States
(12) Patent Application Publication
(10) Pub. No.: US 2008/0303677 A1
(43) Pub. Date: Dec. 11, 2008

(54) Alarm Apparatus and Adaptor

(75) Inventors: Stuart Arthur Hart, Coventry (GB); Nicholas Alexander Rutter, Coventry (GB)

Correspondence Address: YOUNG LAW FIRM, P.C.;ALAN W. YOUNG, 4370 ALPINE ROAD, SUITE 106, PORTOLA VALLEY, CA, 94028, US

(73) Assignee: FIREANGEL LIMITED, COVENTRY (GB)

(21) Appl. No.: 11/909,798

(22) PCT Filed: Apr. 3, 2006
(86) PCT No.: PCT/GB2006/001211

§ 371 Date: Apr. 29, 2008

(30) Foreign Application Priority Data
Apr. 1, 2005 (GB) 0506671.7

(51) Int. Cl. G08B 17/12; H01R 31/06

(52) U.S. Cl. 340/600; 439/628

(57) ABSTRACT

Alarm apparatus for detecting radiation and/or pollutants such as smoke, carbon monoxide or the like comprising a housing means housing an alarm circuit. The alarm circuit includes detection means for detecting the radiation and/or pollutants, alert means for alerting a user of the presence of the pollutant, and control means for controlling the alarm circuit. The alarm apparatus also includes an adaptor comprising first connection means configured for electrically connecting the adaptor to a source of mains electricity, second connection means configured for onward electrical connection to the alarm. The adaptor is configured for fixedly supporting the alarm relative to the source of mains electricity.

The present invention relates to alarm apparatus, an adaptor for the alarm apparatus, and particularly, but not exclusively, to an improved form of mains-powered carbon monoxide alarm.

Electrically powered pollutant detection alarms such as carbon monoxide detectors are well known, such detectors typically include means for electrical connection to a source of mains electricity and/or a battery/rechargeable battery for powering a pollutant detection and alarm circuit.

However, known detectors have any of a number of issues associated with them. These issues include a short battery life either because of the high power consumption of the detection circuit, and/or, in the case of re-chargeable batteries, the repeated and unnecessary top-up recharging every time the mains supply is connected.

Carbon monoxide detectors, in particular, are difficult, time consuming and potentially hazardous to test because a source of carbon monoxide has to be held in the vicinity of the detector for enough time for the gas to build up sufficiently to trigger the alarm.

Detectors are also often difficult to install, lack versatility of location, take up mains power outlet sockets, and/or comprise unnecessarily complex and hence expensive circuitry.

The present invention seeks to provide an improved alarm apparatus for the detection of radiation and/or pollutants and an adaptor for the alarm.

Accordingly the present invention provides an adaptor for an alarm comprising: first connection means configured for electrically connecting said adaptor to a source of mains electricity; second connection means configured for onward electrical connection to said alarm; wherein said adaptor is configured for fixedly supporting said alarm relative to said source of mains electricity.

The first connection means may be configured for electrically connecting said adaptor to a source of mains electricity comprising a light fitting.

The adaptor may further be provided with third connection means configured for onward electrical connection to a further electrical device, thereby preventing loss of an electrical outlet and allowing possible adaptation from one type of outlet to another.

Preferably the third connection means comprises an electrical socket.

Preferably the third connection means is configured for onward connection to a light source. The light source may be an electric light bulb.

The first connection means may be a bayonet plug connection means for connecting to a bayonet socket of a light fitting and said third connection means may be a bayonet socket for receiving a bayonet-connector of a light source.

Preferably the first connection means is a screw plug connection means for connecting to a screw socket of a light fitting and said third connection means is a screw socket for receiving a screw-connector of a light source

Preferably said alarm comprises a housing and said adaptor is further configured to support said housing in a position laterally spaced from said mains power source. This is particularly advantageous for fitting to a standing lamp or the like, to separate the alarm from the lightbulb thereby reducing the heating effect when the bulb of the lamp is on.

The invention also comprises alarm apparatus for detecting radiation and/or pollutants such as smoke, carbon monoxide or the like comprising: a housing means housing an alarm circuit, said alarm circuit including detection means for detecting said radiation and/or pollutants, alert means for alerting a user of the presence of said pollutant, and control means for controlling said alarm circuit; and the adaptor.

The adaptor and the housing may be integral.

Preferably, the adaptor and the housing are discrete elements, said housing having alarm connection means configured for mutual engagement with the second connection means of said adaptor to allow electrical connection of said circuit to said source of mains electricity.

The alert means comprises audible alert means for providing an audible alarm on detection of said radiation and/or pollutants.

Preferably, the audible alarm is a non-voice alarm signal, and the audible alert means further comprises means for providing status and/or alert information in the form of a voice message.

The voice messages may be controlled and stored on a separate voice chip.

Preferably, the control means comprises a controller chip, and the voice messages are controlled by and stored on the control chip.

Advantageously, said alarm circuit may comprise audio output means configured to output both said audible alarm and said voice messages from a single speaker, thereby reducing cost and complexity.

Preferably, the audible alarm and/or said voice messages are derived from audio signals, and the audio output means comprises amplification means for increasing the magnitude of said audio signals for increased audio volume of said output from said speaker.

The amplification means may comprise a power amplifier.

Advantageously the power amplifier may be powered by a voltage derived from a step-up power supply, thereby negating the need for a transformer.

Preferably, the alarm circuit comprises audio output means configured to output both said audible alarm and said voice messages from a single speaker without the need for a transformer.

The alert means may additionally or alternatively comprise visual alert means.

The alarm circuit preferably comprises a rechargeable battery for allowing the continued supply of power to said alarm circuit when said source of mains electricity is absent.

Preferably, the alarm circuit is provided with means for recharging said battery from said mains supply when said mains supply is electrically connected via said adaptor to said alarm circuit. This is particularly advantageous for alarms fitted to light fittings whereby the battery is recharged when the light is on, and powers the alarm circuit when the light is off.

Preferably, the recharging means includes a non-inductive step-down power supply.

Preferably, the alarm circuit includes means for detecting the charge level of said battery and wherein said control means are configured to monitor said charge level and to only allow recharging of said battery when said charge level falls below a predetermined level.

Preferably, the detection means comprises a sensor for sensing said pollutant.

The sensor may comprise a semiconductor sensor.

The sensor may alternatively or additionally comprise an electrochemical sensor.

The alarm circuit is preferably configured to sample said sensor at a sample rate controlled by said control means and said control means is preferably configured to sample at a lower rate when said alarm circuit is not electrically connected to said source of mains electricity, thereby reducing power consumption in the absence of a mains supply.

Preferably, said alarm circuit comprises means for manually inducing an enhanced sampling rate for rapid sensing of said radiation and/or pollutant. This mode of operation is particularly advantageous for testing the alarm with a locally introduced source of pollutant and/or radiation.

A further aspect of the present invention provides an alarm for detecting radiation and/or pollutants such as smoke, carbon monoxide or the like having: first connection means for connecting said alarm to a light fitting; second connection means for connecting said alarm to a light source; housing means housing a pollutant detection means, an audible alarm, an alarm circuit and a battery for powering the alarm during periods of non-use of said light fitting; and electrical connection means connecting said first and second connection means to enable said light source to be powered from said light fitting; wherein said housing is spaced laterally from and supported by said connection means.

In a preferred form of the invention said first connection means is a screw plug connection means for connecting to a screw socket of a light fitting and said second connection means is a screw socket for receiving a screw-connector of a light source.

The present invention also provides an alarm for detecting radiation and/or pollutants such as smoke, carbon monoxide or the like having: a housing means; an alarm circuit including detection means for detecting said radiation and/or pollutants; first electrical connection means connectable to an external power supply for supplying power to said alarm circuit and supported laterally of the housing; and control means for controlling said alarm circuit.

The present invention is further described hereinafter, by way of example, with reference to the accompanying drawings, in which:

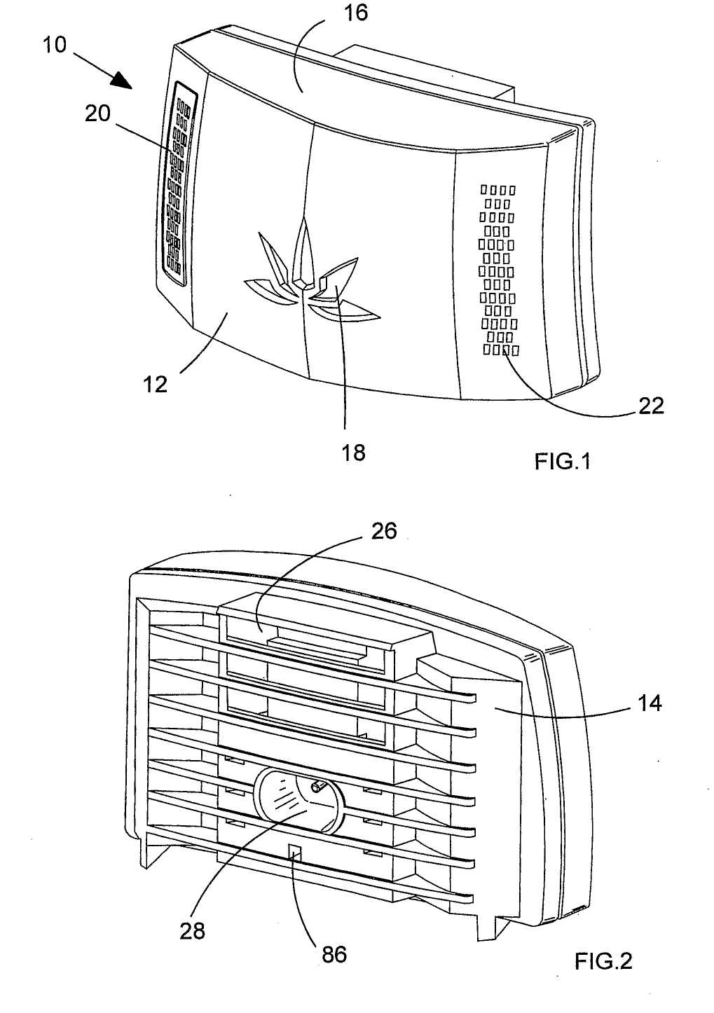

FIG. 1 is a perspective view of a housing of a preferred form of alarm according to the present invention;

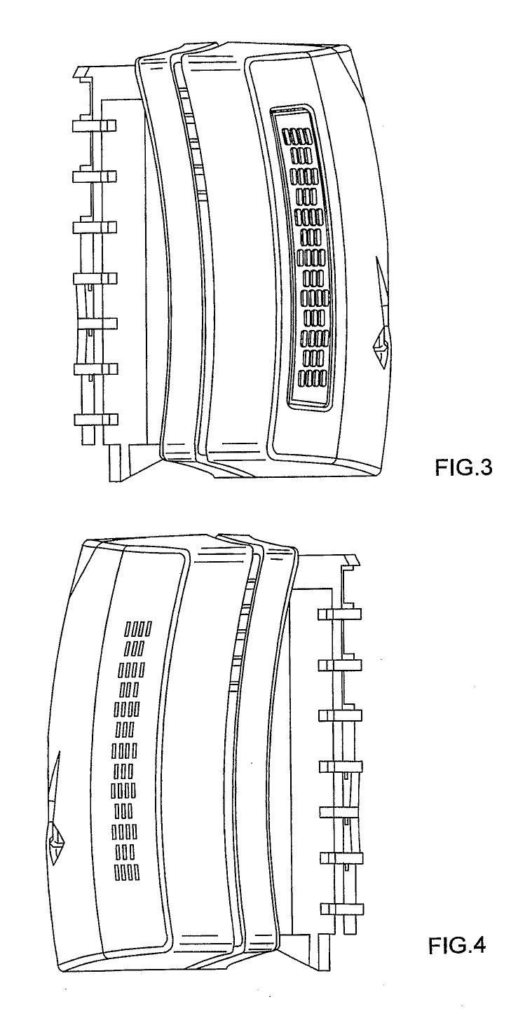

FIG. 2 is a rear view of the alarm of FIG. 1;

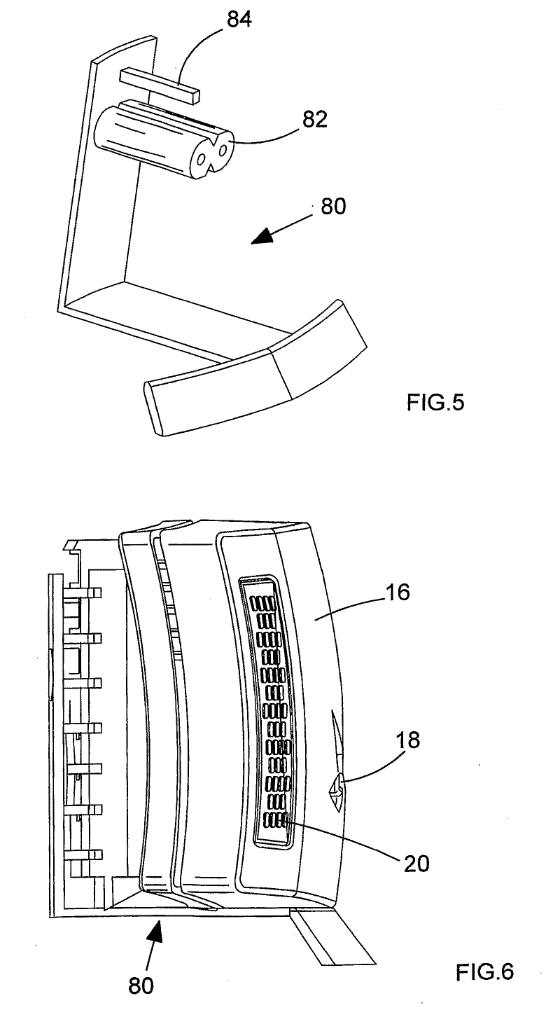

FIG. 3 is a side elevation of the alarm of FIG. 1;

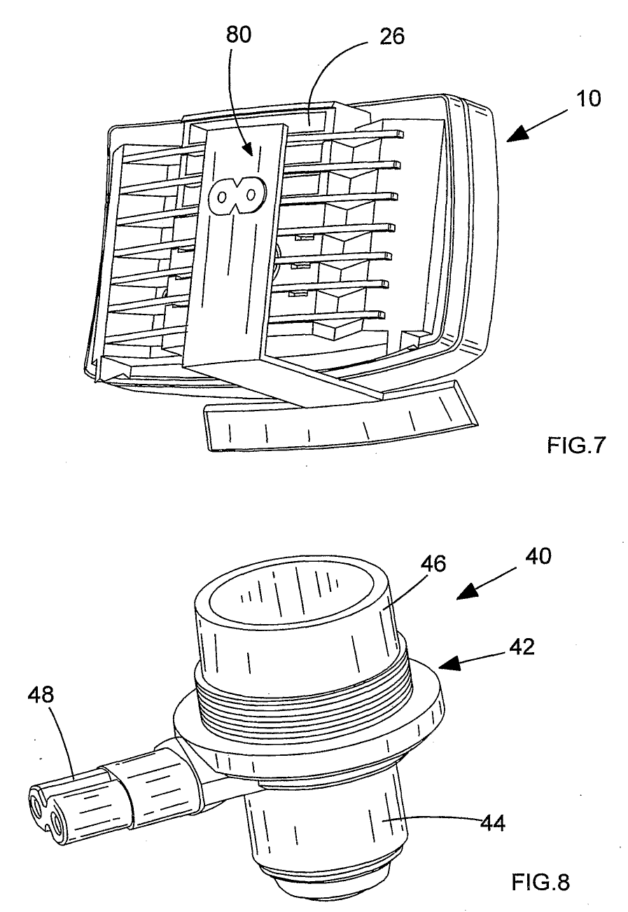

FIG. 4 is an opposite side elevation of the alarm of FIG. 1;

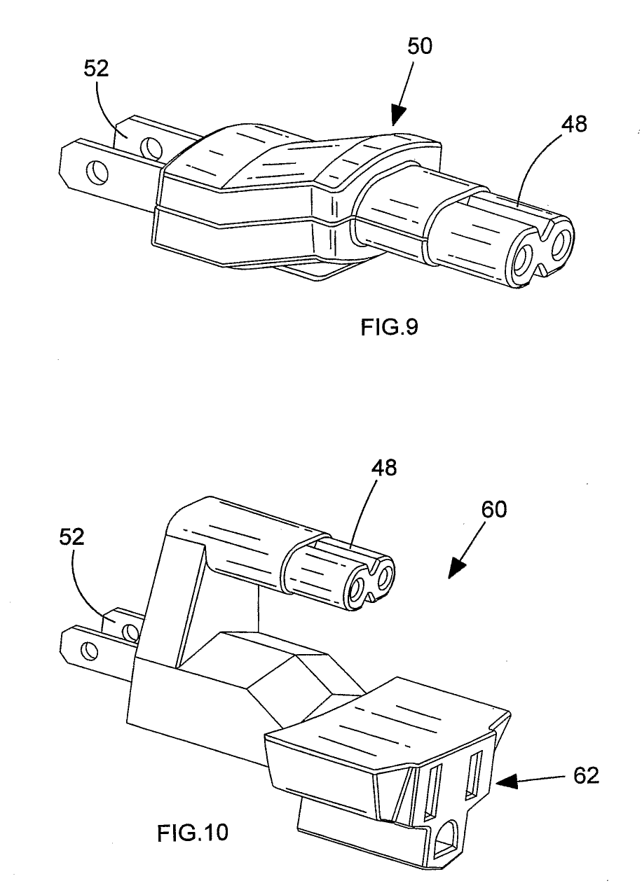

FIG. 5 is a perspective view of a shipping disable device for the alarm of FIG. 1;

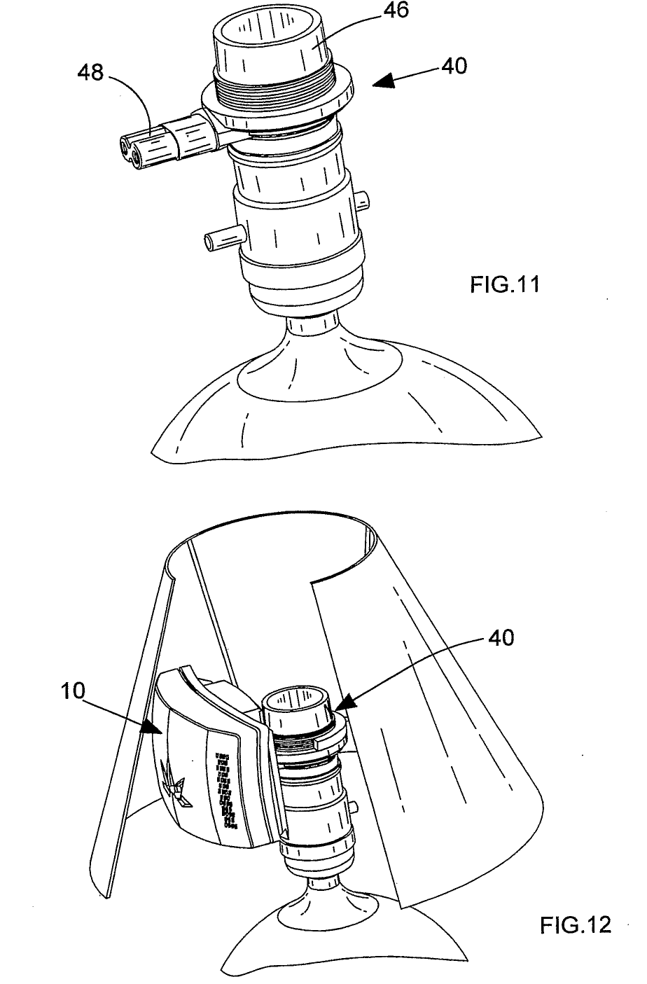

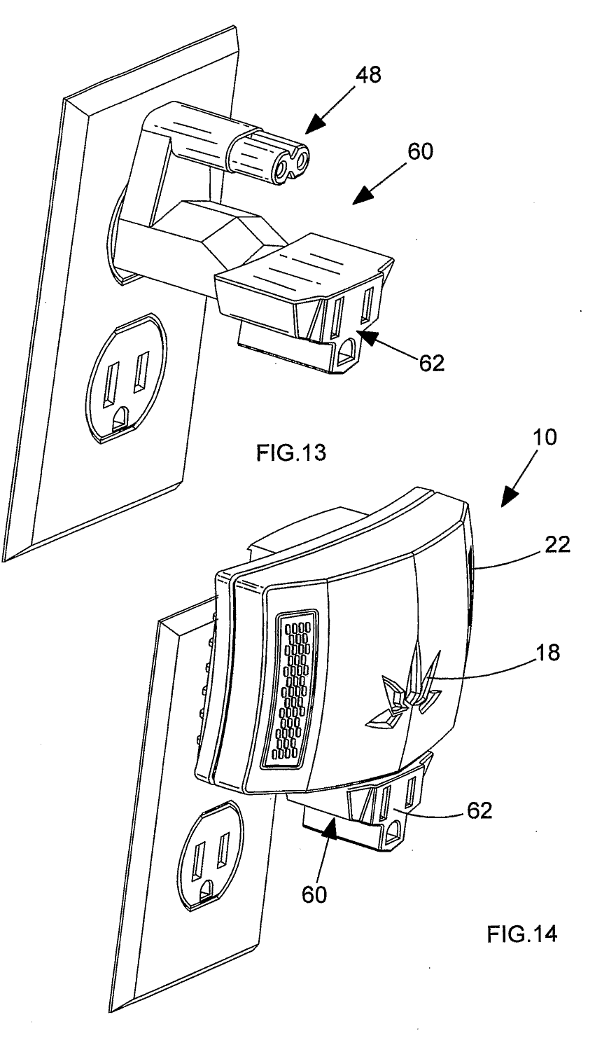

FIGS. 6 and 7 are views of the alarm showing the shipping disable device attached;

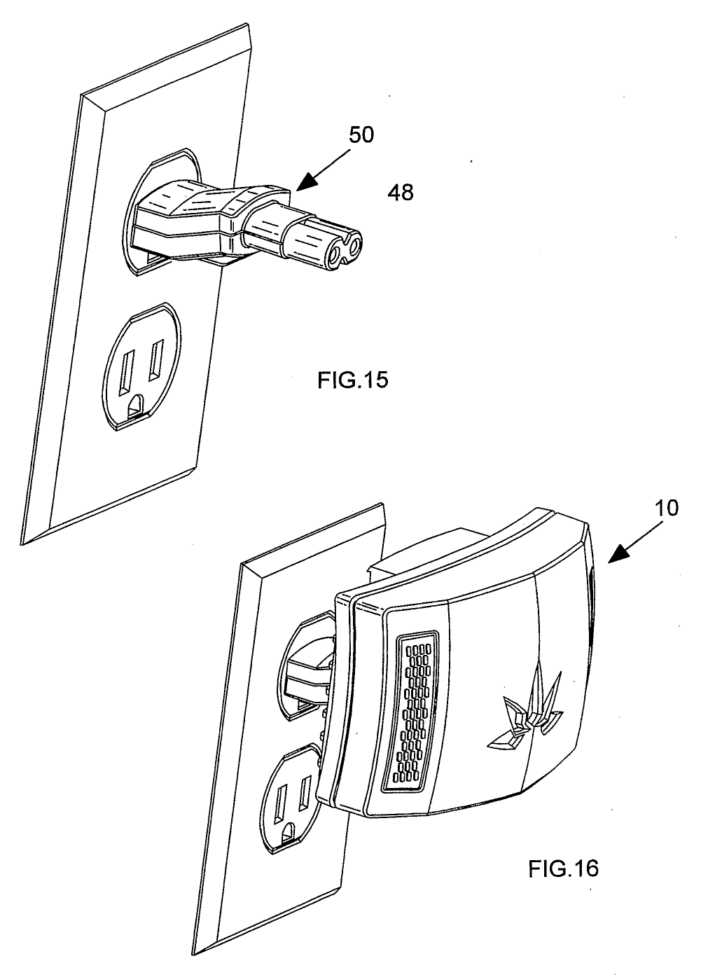

FIG. 8 is a view of a lamp holder adaptor for the alarm of FIG. 1;

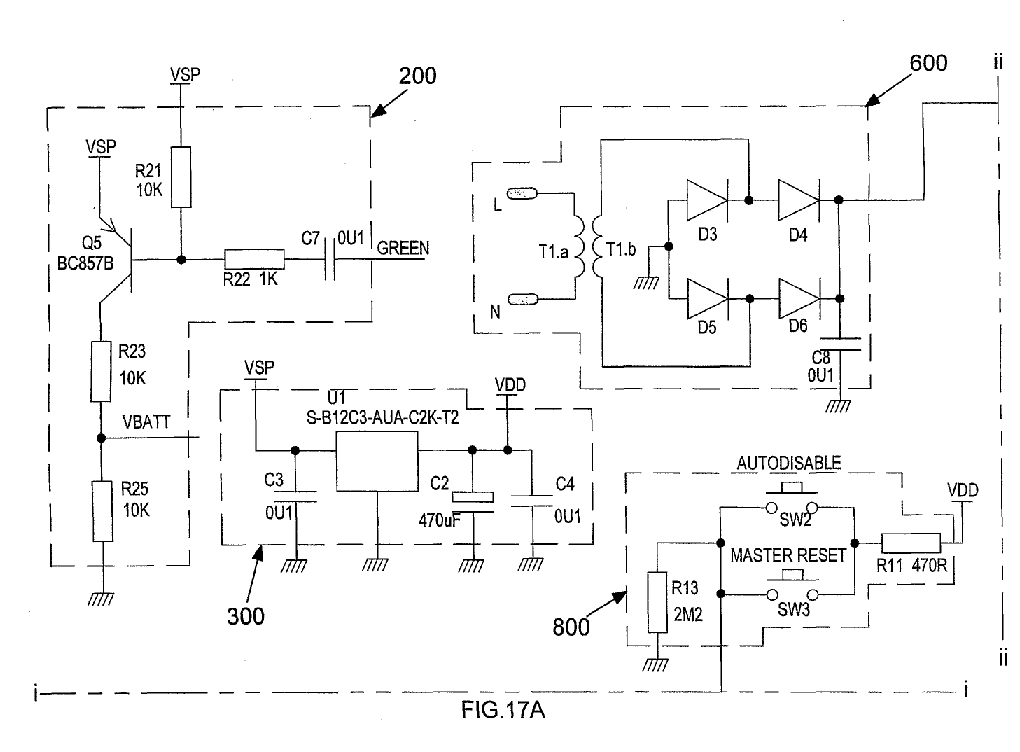

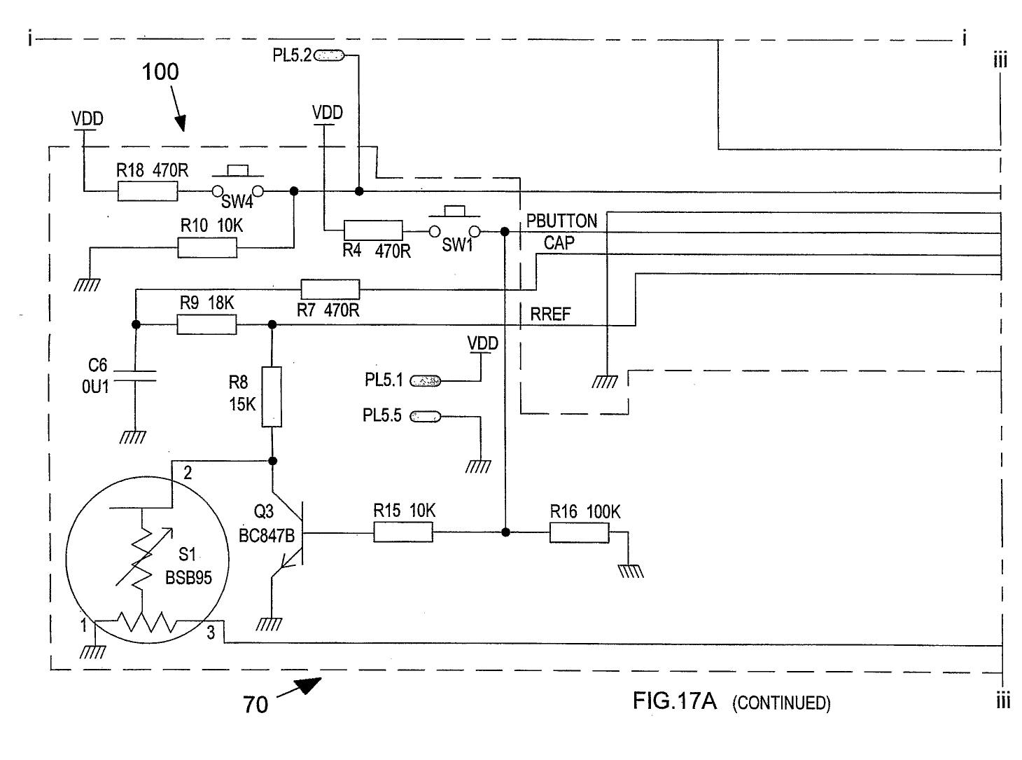

FIGS. 9 and 10 are views of adaptors for connecting the alarm of FIG. 1 to a mains power socket;

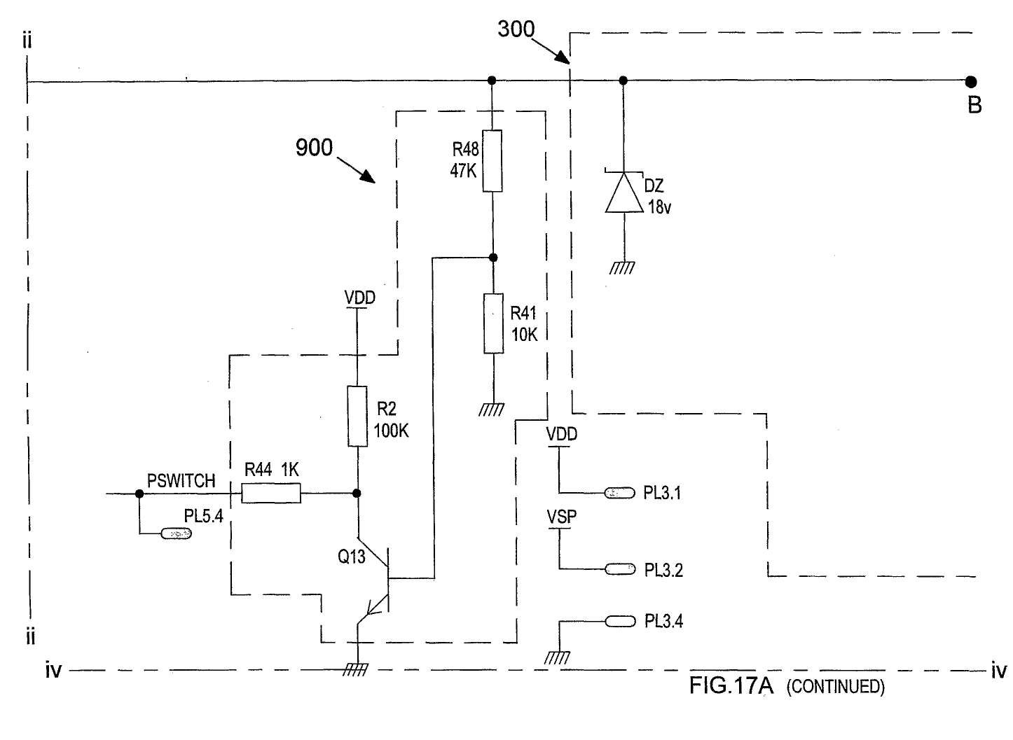

FIG. 11 shows the adaptor of FIG. 8 connected to a standard lamp socket;

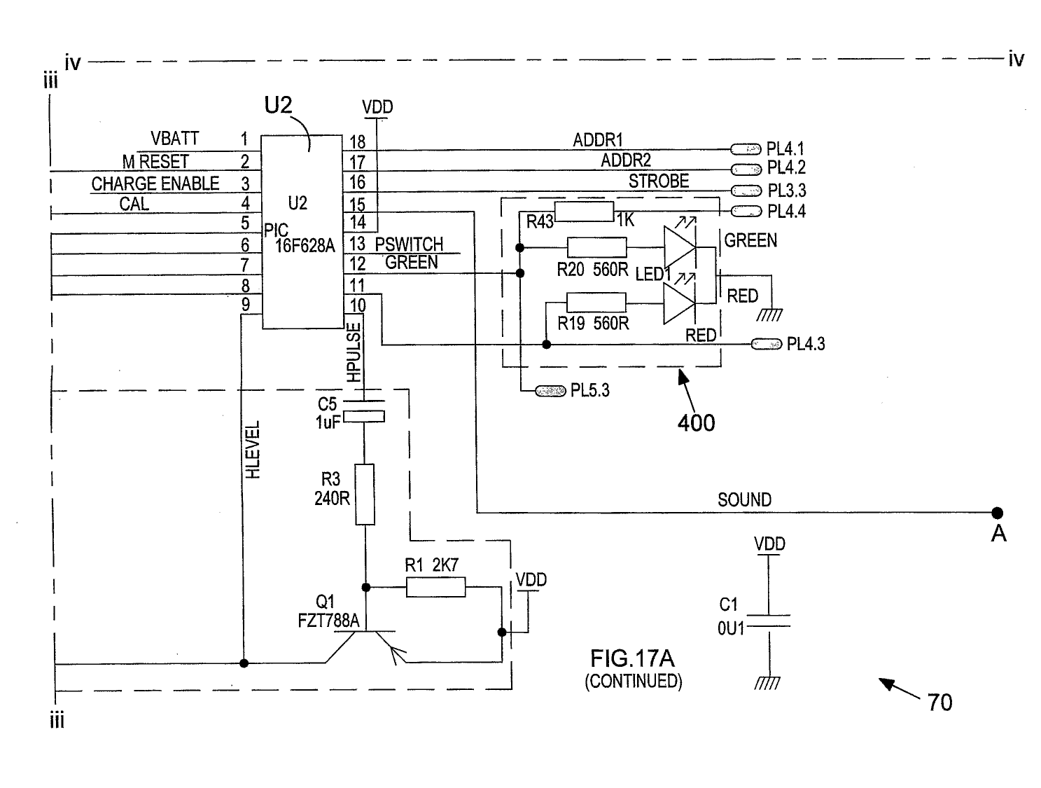

FIG. 12 shows the alarm of FIG. 1 connected to the adaptor of FIG. 8 in situ;

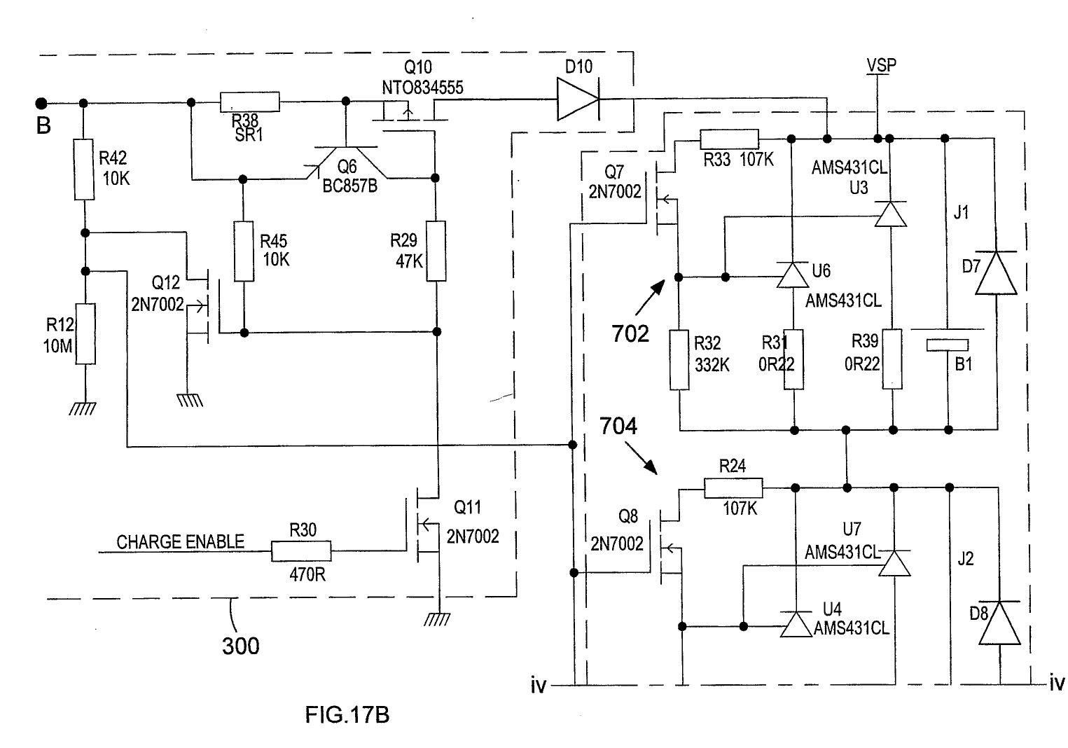

FIG. 13 shows the adaptor of FIG. 10 connected to a mains power socket;

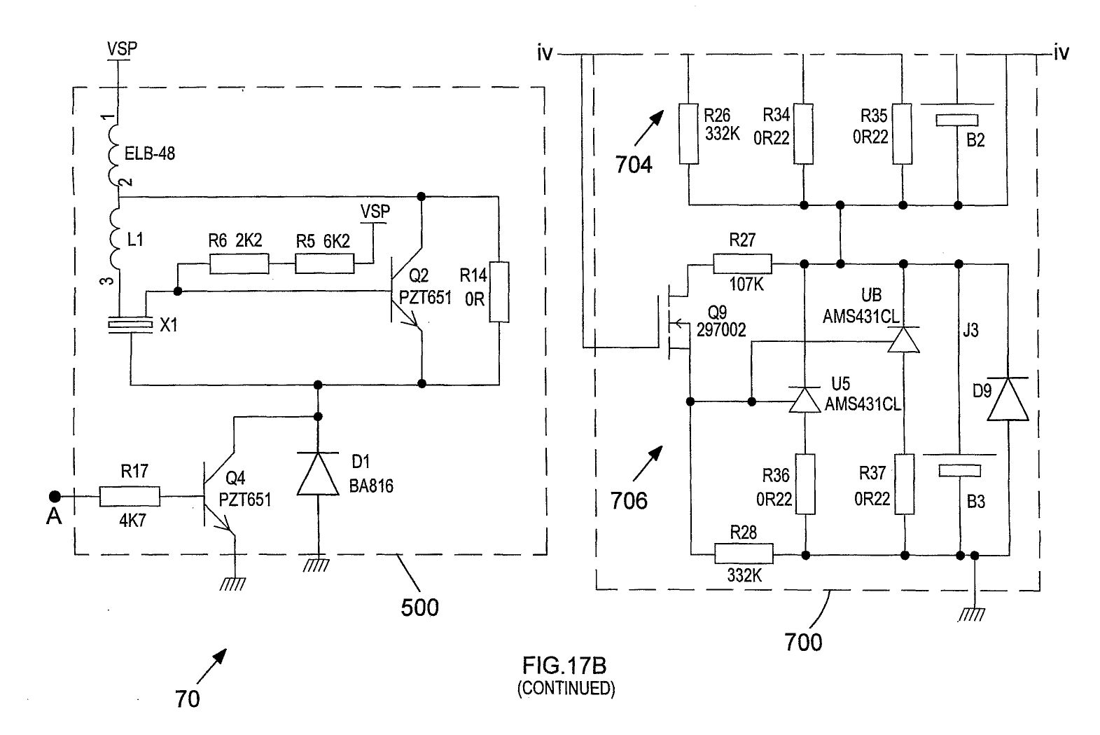

FIG. 14 shows the alarm of FIG. 1 mounted on the adaptor of FIG. 13;

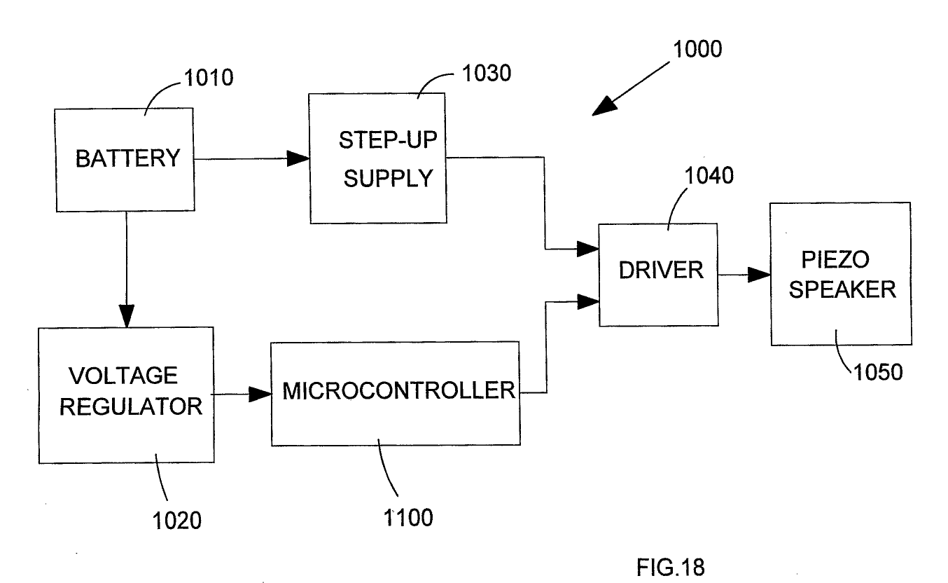

FIG. 15 shows the adaptor of FIG. 9 connected to a mains power socket;

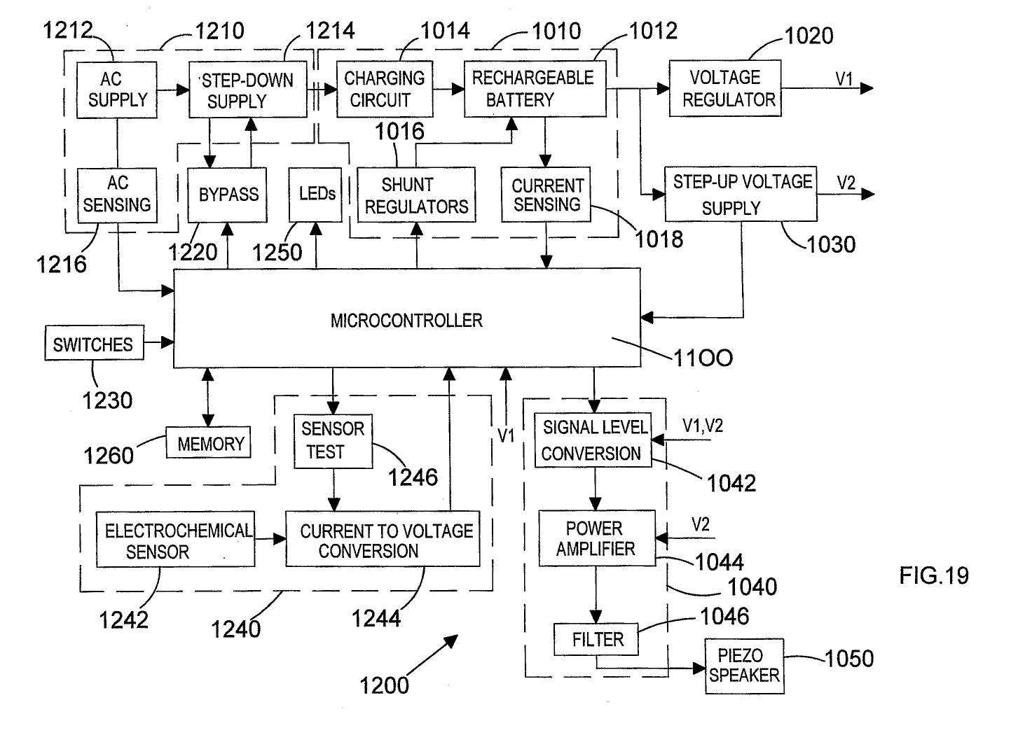

FIG. 16 shows the alarm of FIG. 1 mounted on the adaptor of FIG. 15;

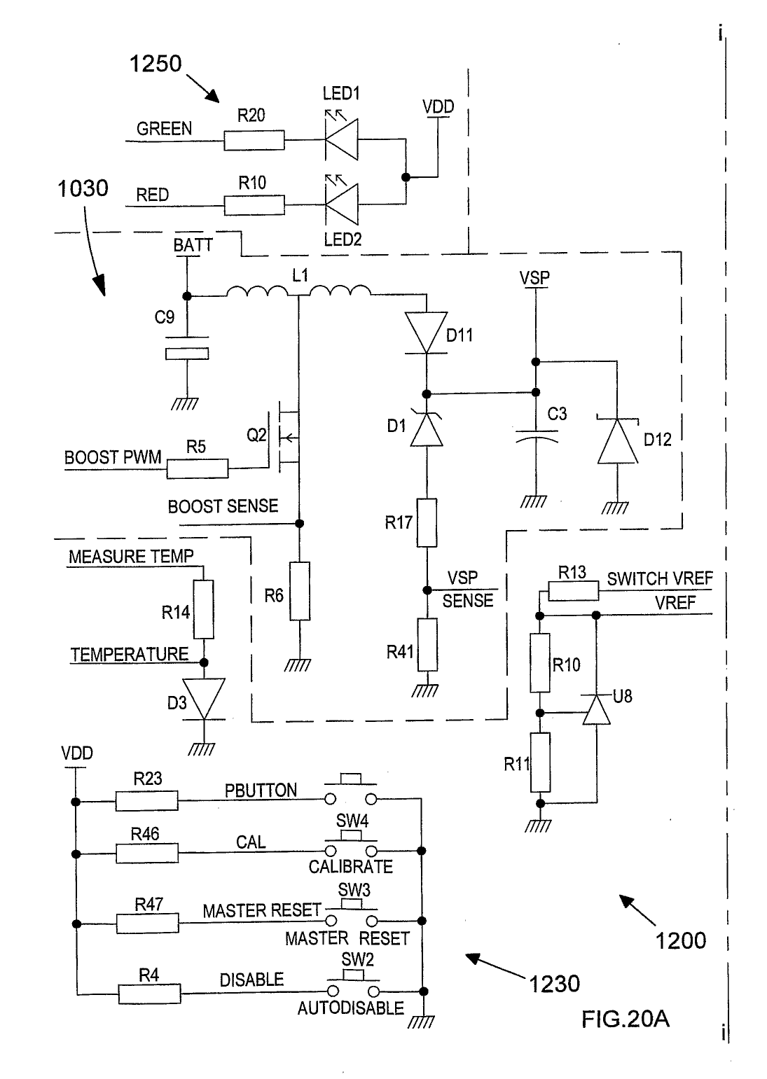

FIG. 17 is a circuit diagram of the alarm of FIG. 1;

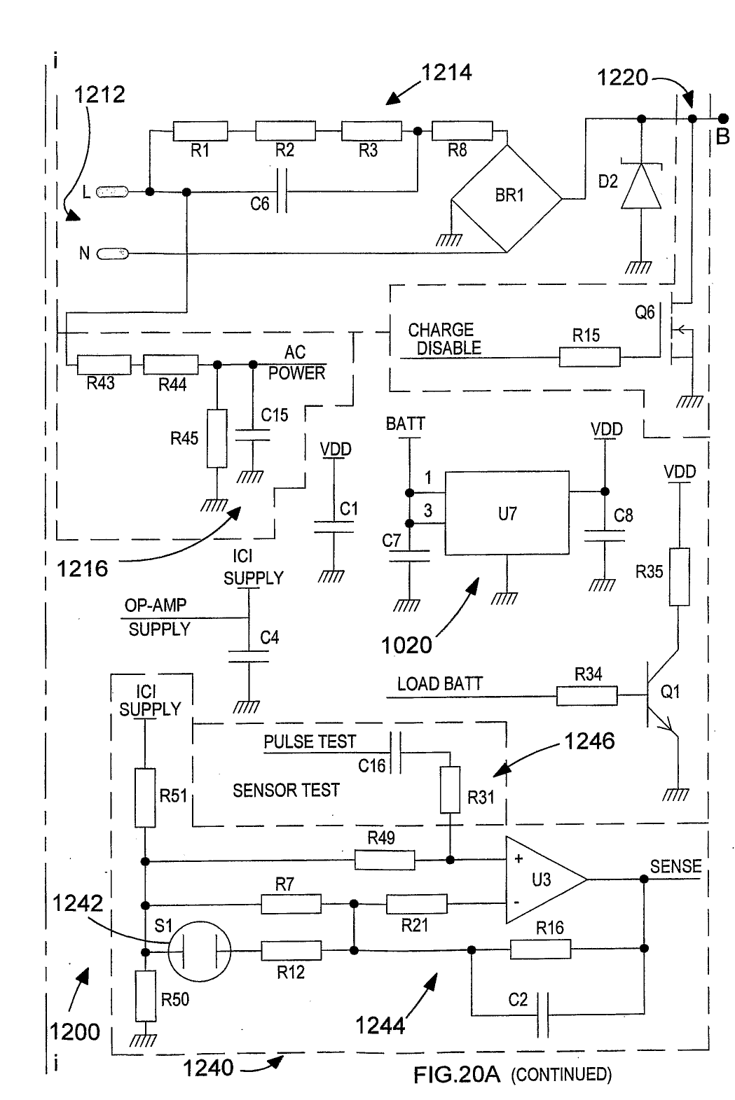

FIG. 18 is a simplified block schematic of an integrated voice/alarm circuit portion;

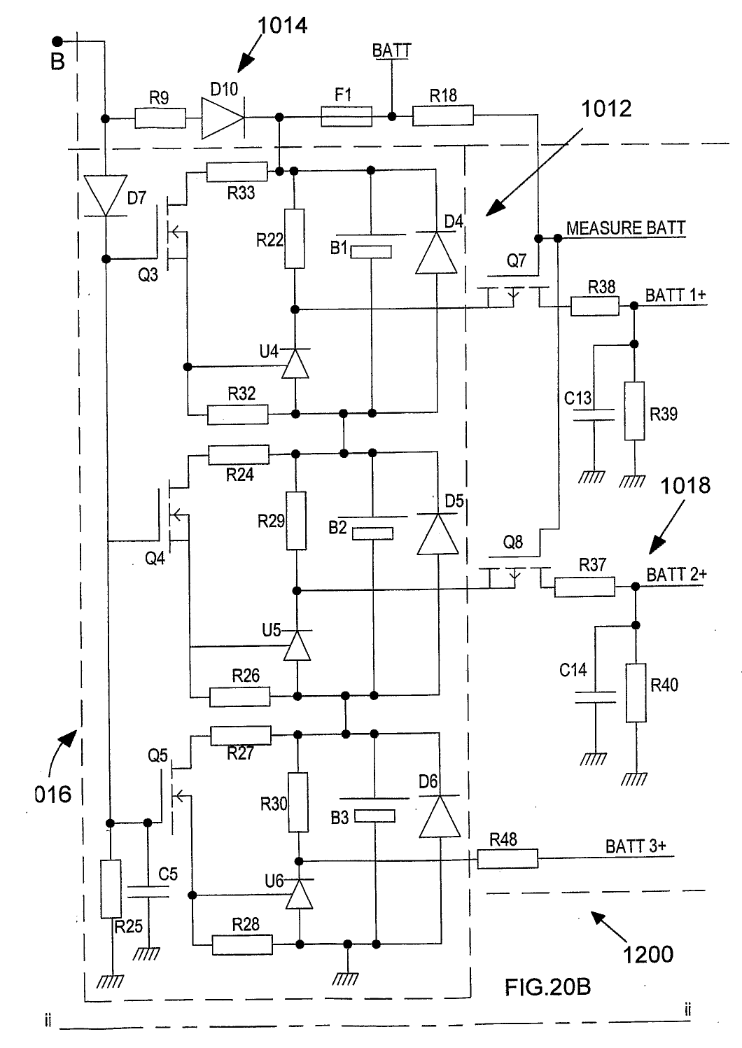

FIG. 19 is a simplified block schematic of an alarm circuit including the circuit portion of FIG. 18; and

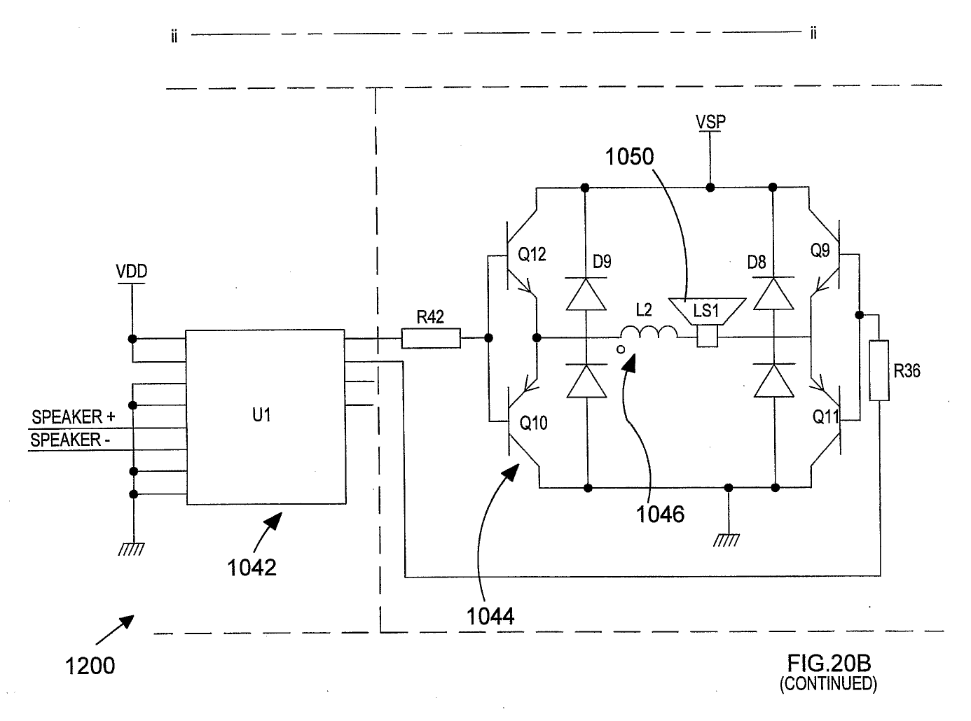

FIG. 20 is a component level circuit diagram of the circuit of FIG. 19.

Referring to the drawings, these show an alarm 10 having a housing 12 with a rear face 14 and a front face 16, the latter being generally arcuate in cross-section although as can be seen from FIG. 1, the arc of the face is formed by individual segments.

The housing has alarm sounder vents 18, a push button operating switch 20 and speaker vents 22. An LED indicator (not shown) is provided for indicating operation of the alarm.

Referring to FIG. 2, it can be seen that the rear face has cooling vents 26 and a power connection means in the form of a socket 28 having power pins for connection to one of the adaptors for use with the housing.

One form of adaptor 40 is shown in FIG. 8. This is for use with a conventional standard or table lamp, and has a core section 42 having a plug end portion 44 and a socket end portion 46, these portions being axially aligned, although it will be appreciated that this is not essential.

The plug and socket portions 44, 46 can be either bayonet plug and socket portions for use in those countries which have this type of light source connection as standard, or can be screw plug and socket connections for use in, for example, North America. The latter can be used with, for example, 3-way bulbs.

As can be seen from FIG. 8, the adaptor also has a laterally extending connection means 48 in the form of a plug, shaped for mutual engagement with the socket 28 of the housing 12.

The adaptor has connection means, conveniently in the form of strip connectors or wires, which connect the plug 44 and socket 46 to enable power to be passed from the lamp socket to the bulb when the adaptor is in use. In addition, the connection means is also connected to power leads in the plug 48, such that when the plug 48 is engaged in the socket 28 of the alarm housing, power is transmitted to the alarm circuitry when the lamp standard is switched on to supply power to the light source.

FIG. 11 shows the adaptor 40 connected to a socket of a table lamp and FIG. 12 shows the alarm housing connected to the adaptor 40.

FIGS. 9 and 10 show two further forms of adaptor for connecting the alarm to a mains power socket. FIG. 9 is a simple connector 50, which has pins 52 for connection to the mains socket and a plug 48, similar to plug 48 of adaptor 40, for supplying power to the alarm.

FIG. 10 shows a further adaptor 60, which has pins 52 and a plug 48 but in addition, also has a further power socket 62 for allowing connection of a separate powered device such as, for example, a domestic appliance.

FIG. 15 shows the adaptor of FIG. 9 plugged into a mains socket, whilst FIG. 16 shows the alarm of FIG. 1 mounted on the adaptor 50.

FIG. 13 shows the adaptor 60 of FIG. 10 plugged into a mains power socket and FIG. 14 shows the alarm 10 of FIG. 1 mounted on the adaptor 60.

Although the adaptors 50 and 60 are shown for use with twin pin power sockets as are used in North America, it will be appreciated that the pins 52 may be replaced by pins suitable for engagement in power sockets used in other countries such as the three pin arrangement used in the United Kingdom.

Referring now to FIG. 17, this shows a circuit diagram of the main circuit 70 of the alarm 10. This includes a carbon monoxide sensing circuit 100, a battery voltage monitoring circuit 200, a voltage regulation circuit 300, a visual display circuit 400, an audio alarm circuit 500, a power supply circuit 600, a battery supply circuit 700, a disable circuit 800 and a test and reset circuit 900.

The circuit 70 is controlled by a microcontroller U2. The voltage monitoring circuit 200 applies a battery voltage from the battery circuit 700 across a resistive divider to provide a voltage VBATT for voltage monitoring, this being applied to the microcontroller U2.

The circuit 300 includes a voltage regulator U1 which provides a regulated through volt DC supply from the voltage supplied by the battery circuit 700.

The visual monitoring circuit 400 is a dual chip device, providing a combination of colours (red, green, orange). These are used to indicate alarm, fault and other conditions as required by the appropriate type testing for CO alarms.

The audible warning circuit 500 has a piezo buzzer X1 used to provide a high volume audible alarm signal. An inductance L1 is used to tune the buzzer, providing a louder output than would otherwise be possible.

Carbon Monoxide Sensing Circuit 100

This circuit has a semiconductor sensing device S1, which consumes a significant amount of power when active. It can also be operated in different modes, each of which correlates to a different power consumption. When there is no ac power available, the frequency at which S1 is activated has a direct effect on battery current consumption and consequently time between required recharges. Under these conditions, U2 is programmed to activate S1 at the minimum frequency and lowest power operating mode acceptable.

When ac power is available, there is more current available for circuit operation; the consequence will be an increased charging time, which will not be significant unless the extra power drain is fairly considerable. U2 is programmed under these conditions to use S1 at a more optimised frequency and operating mode.

Battery Circuit 700

This comprises battery circuits 702, 704, 706 each of which has a rechargeable alkaline cell (B1, 2, 3) all connected in series to form a battery. These provide power directly to the buzzer circuit 500, to allow maximum possible sound output. All of the other circuits are powered from the 3V regulator circuit 300.

The battery is recharged from the mains supply through power supply circuit 600, which has a transformer T1 and diode rectifiers D3-D6. The regulator circuit 300 limits the charging current to the battery for three reasons:
1 To maximise the charging current available from a transformer of a given rms current rating.
2 To enable this maximum current to be provided for a wide range of mains supply voltages without overloading the transformer.
3 To improve the charging voltage stability (see below).

Each cell B1, B2, B3 has a bypass diode (D7, D8, D9) that allows current from other cells to bypass an open circuit or discharged cell, ensuring a continuous dc supply and without damage to discharged cells.

Each cell also has a shunt regulator circuit formed by (U3 & U6 on B1). These switch on at a precisely controlled voltage determined by R32 & R33. Two regulators are used to share the load, as the current is too high for one device. R31 & R39 ensure current sharing between devices. These resistors will change the voltage setting of the regulators but as the normal maximum current is limited to a constant value by circuit 300, this is a fixed offset and can be allowed for in component selections.

Each shunt regulator circuit is normally switched off (negligible leakage current) when there is no charging current available, as the associated field effect transistor is switched off. These are usually switched on every time the battery is charging, when the instantaneous rectified ac voltage supply is sufficiently high. This function ensures that the battery is not rapidly discharged when ac power is not present.

As well as individual cell protection against overcharge, the overall battery voltage is monitored by U2 through the voltage monitoring circuit 200. When the overall battery voltage is very slightly below the value defined by the combined individual cell shunt regulator circuits, U2 applies a signal along the “charge enable” line to transistor Q11 of the control circuit 300. This switches off transistor Q10 to prevent further charging current being supplied to the battery. In addition, whenever there is charging present, Q12 will be switched on, which in turn switches off the shunt regulator circuits of the battery circuit 700, regardless of whether or not ac power is applied to the circuit.

Following this operation, the overall battery voltage is allowed to gradually decay. When it reaches a predetermined level Q11 is switched on, and the battery is allowed to recharge again.

This feature has two benefits:
1 The battery is cycled between fall charge and slight discharge rather than being continuously charged (when ac is frequently present), which is an optimum operating condition for the type of battery used.
2 Heat dissipation is minimised inside the electronics, reducing the average temperature and extending battery and electronics lifetime.

Self Test & Reset Circuit

The alarm can be self tested and/or reset either by a large, momentary action pushbutton switch (SW1, pressed once) of circuit 100 or by switching the ac power on and off a predetermined number of times (at least twice). SW1 operation is detected directly by U2, whilst ac power switching is detected indirectly by Q13 of circuit 900. When the ac power is rapidly switched on and off, Q13 is also rapidly turned on and off, sending pulses along the PSWITCH line for subsequent detection by U2.

Calibration

Normal alarm operation is based on an integrating function of sensed CO gas over an extended period, rather than triggering on a simple threshold. Momentary operation of SW4 of the circuit 100 forces U2 into a rapid sensing mode and triggering on a simple threshold, so the direct reaction of the alarm to locally introduced CO gas can be checked.

Autodisable/Master Reset Circuit 800

This circuit has two separate switches SW2 & SW3. SW3 is a momentary action switch intended to reset U2. SW2 is wired in parallel with SW3, but is a “detector” type switch maintained in a closed condition when a “disable flag” is inserted into the ac power inlet of the alarm.

FIG. 5 is a perspective view of a disable flag and FIG. 6 shows the disable flag attached to the alarm 10.

The disable flag 80 has a dummy plug 82 which is inserted into the socket 28 of the housing 12 in order to prevent insertion of one of the adaptors for the alarm. In addition, the disable flag also has a spigot 84, which is inserted into a disable slot 86 in the rear face 14 of the housing of the alarm. Insertion of the spigot 84 into the disable slot closes switch SW3.

It is physically very obvious that the flag 80 has been fitted.

As well as physically disabling the alarm, the presence of the flag (as detected by SW2) causes U2 to go into a very low power operating mode, so that it no longer operates as an alarm. The total current consumption of all circuits of the alarm is thus very low, and the alarms can be stored for years in this condition without deep discharging of the battery. A disabling flag is fitted to each unit during production and they are shipped in this condition.

Voice Chip

As well as controlling the multifunction LED circuit 400 to give a visual indication of operating status, U2 also controls a voice messaging chip. This is not shown in FIG. 17. The chip is on a separate PCB, connected via 4-way headers PL3 and PL4 to the controller U2. A loudspeaker is connected to the output of the voice chip.

When no messages are to be spoken, the voice chip operates in a very low power mode to minimise battery drain. On receipt of an appropriate signal from U2, a spoken message is generated relevant to alarm status. On completion of the message, the chip returns to its very low power mode. This particular function is extremely useful when the alarm is positioned such that the LED's of the circuit 400 cannot be seen, for example when the alarm is positioned within the shade of a table lamp such as shown in FIG. 12.

The alarm can easily be installed either by plugging into a wall power socket or into any table lamp socket.

The rechargeable battery draws power from the electrical source (either the wall socket or the table lamp socket). When installed in the table lamp, the battery charges whenever the table lamp is switched on. Once fully charged, the battery holds sufficient power to operate the without further charging for up to 45 days. If a long period occurs without the battery being charged, i.e., without the table lamp being switched on, the alarm is controlled by U2 to issue a short sound, such as a chirp through the audio circuit 500 every minute to remind the user that charging is required. When plugged into a wall socket, the battery will charge continuously whilst the socket is “on”.

Voice/Alarm Integration

In an alternative embodiment of the circuit the voice and alarm are integrated to provide a voice message or alarm condition output from a single piezo speaker. FIG. 18, shows a simplified block schematic of an integrated voice/alarm circuit portion generally at 1000. The integrated circuit comprises, a battery portion 1010, a voltage regulator portion 1020, a controller portion 1100, a step-up supply portion 1030, a driver portion 1040, and a piezo speaker 1050.

In the circuit portion 1000 the battery portion 1010, which may be similar to the battery circuit 700, is configured to provide power to the regulator portion 1020, and the step-up supply portion 1030. The voltage regulator portion is configured to provide a voltage appropriate for operation of the controller portion 1100, for example, a voltage in the range 3V to 5V.

The controller portion 1100 comprises a chip configured to provide both voice message signals and alarm signals to driver portion 1040. The microcontroller 1100 is also configured for the control and monitoring functionality required for the rest of the alarm circuit, including the step-up supply. Hence, in the circuit portion 1000, the functionality of the voice chip and the microcontroller U2 described earlier are integrated into a single microcontroller chip, giving the advantage of improved integration and reduced manufacturing costs.

It will be appreciated that, where appropriate, the battery voltage may alternatively be applied directly to the controller portion 1100 in dependence on the type of microcontroller used, thereby negating the need for a separate voltage regulator.

The step-up supply portion 1030 is configured to provide an appropriate stepped-up DC supply voltage for powering the driver portion 1040. Typically, for example, the step-up supply portion is configured to supply a voltage in the region of 18V.

The driver portion 1040 is configured to convert the voice message or alarm signal from the controller portion 1100 into an audio signal suitable for output via the piezo speaker 1050. The provision of the stepped-up supply voltage to the driver portion 1040 allows the output of the driver portion 1040 to be of sufficient amplitude to ensure that the the voice message, or alarm outputted from the speaker 1050 is audible at a required level.

In known circuits for providing integrated voice and alarm signal output, a transformer is required between a driver portion and a piezo speaker in order to provide an audible output of sufficient volume. The inclusion of a transformer makes the circuit more expensive to manufacture.

Alternative Circuit Embodiment

In FIGS. 19, and 20 an alternative embodiment of the circuit which includes integrated voice/alarm functionality is shown generally at 1200. The circuit 1200 includes the integrated voice/alarm circuit portion 1000 and like parts are given like reference numerals.

The circuit 1200 comprises a plurality of elements including: a supply portion 1210; a battery portion 1010; a bypass element 1220; a regulator portion 1020; a step-up supply portion 1030; a driver portion 1040; a piezo speaker 1050; a switching portion 1230; a carbon monoxide sensor portion 1240; and a visual display portion 1250. The circuit elements are controlled by a microcontroller 1100.

The supply portion 1210 comprises AC input means 1212, a step-down supply element 1214, and an AC sensing element 1216. The AC input means is configured for allowing interconnection with the live and neutral rails of an AC power supply, for example, a mains power supply, and for the onward supply of the AC power to the step-down element. 1214. The step-down element 1214 is configured to reduce and rectify the AC voltage to produce a rectified output voltage to the battery portion 1010 for charging purposes. A zener diode D2 is provided on the rectified output to limit the output voltage of the supply portion appropriately.

The supply portion 1210 includes a rectifier BR1 as generally described with reference to power supply circuit 600. However, unlike circuit 600 the supply portion does not include a transformer, but instead includes a reactive voltage dropper comprising capacitor C6 in parallel with resistors R1, R2, R3, and in series with resistor R8.

The AC sensing element 1216 is configured to provide an AC power signal to the controller indicative of the presence or absence of an AC power supply. In operation, the signal is used to determine whether self test/silence function is required, and for battery management.

The battery portion comprises a rechargeable battery element 1012, a charging circuit element 1014, a shunt regulator element 1016, and a current sensing element 1018. The battery element 1012 comprises a plurality of battery circuits each of which has a rechargeable alkaline cell (B1, B2, B3) all connected in series to form a battery, and each of which is provided with an associated bypass diode (D4, D5, D6), as generally described earlier.

The shunt regulator element 1016 comprises a plurality of shunts (U4, U5, U6), each for regulating an associated cell. Each shunt is provided with an associated transistor switches Q3, Q4, Q5 configured to switch off, when no charging current is available, thereby reducing shunt current to substantially zero, thus preventing drain from the cells. A diode-capacitor arrangement D7,C5 is also provided to maintain the gate voltage on each transistor Q3, Q4, Q5 at the peak AC voltage, in use when charging current is available, thereby ensuring each transistor is switched fully on and consequently correct shunt operation.

The bypass element 1220 is configured to switch into a low impedance ON state, to divert current away from the charging circuit element 1014, when the battery 1012 has reached full charge. The bypass element 1220 is further configured to switch into a high impedance OFF state, when the battery voltage has dropped slightly. The use of the bypass increases the lifetime of the battery. Furthermore, as the step-down supply circuit uses a reactive voltage dropper, power consumption drops slightly when the bypass element is active. A bypass of this configuration is also cheaper and simpler than a series switch.

The current sensing element 1018 comprises a plurality of resistors (R22, R29, R30), each connected in series with an associated shunt U4, U5, U6. In operation, the voltage on each of the current sensing resistors R22, R29, R30, is periodically monitored with the bypass element 1220 activated, by the controller 1100, to measure the voltage on each associated cell. The voltage is also monitored with the bypass element 1220 disabled, when charging current is available.

The difference between the measured voltage with the bypass element 1220 activated, with the bypass element 1220 disabled, is indicative of the current through the corresponding shunt, and hence, whether the associated cell is fully charged.

The two cells B1, B2, at the higher voltage end of the series arrangement are each provided with means for reducing the voltage output from the current sensing element. The voltage reduction means comprises an associated transistor Q7, Q8, for switching the output on and off, and a potential divider (R37, R40 & R38, R39).

The voltage regulator 1020 comprises a voltage regulator circuit based around a regulator chip U7, similar to the corresponding circuit based around the voltage regulator chip U1 in circuit 70.

The step-up voltage supply comprises a boost converter for increasing the supply voltage to the driver portion 1040 for the speaker 1050.

The driver portion 1040 includes a signal level conversion portion comprising a dedicated integrated circuit U1, a power amplifier portion 1044, and a filter portion 1046 comprising an inductive filter L2. The power amplifier portion 1044 comprises an amplifier circuit having two complementary pairs of transistors (Q12, Q10 & Q9, Q11).

The switching portion 1230 comprises a test/reset switch SW1, a disable switch SW2, a master reset switch SW3, and a calibration switch SW4. The operation of the autodisable and master reset switches SW2 and SW3 is similar to the operation described with reference to the disable/master reset circuit 800. Similarly operation of the test/reset switch SW1 and the calibration switch SW4 is generally as described with reference to the self test circuit and calibration circuit of main circuit 70, respectively.

The sensor portion 1240 comprises a carbon monoxide sensor 1242, a current to voltage converter element 1244, and a sensor test element 1246.

The carbon monoxide sensor 1242 comprises an electrochemical sensor in contrast to the semiconductor sensor described with reference to sensor circuit 100. The electrochemical sensor 1242 is a low power alternative to the semiconductor sensor. In operation, the sensor 1242 generates an output current, which is dependent on carbon monoxide concentration. Typically, for example, the current is proportional to the concentration.

The current to voltage converter element 1244 comprises a circuit configured to maintain a low magnitude voltage, close to zero volts, to provide substantially optimum operating conditions for the sensor 1242. The circuit 1244 is further configured to produce an output voltage which is proportional to the current produced by the sensor, and hence carbon monoxide concentration.

The current to voltage converter circuit 1244 is further provided with a dc offset comprising a pair of resistors R50, R51, arranged to allow use of a single rail supply.

The sensor 1242 behaves like a current source in parallel with a very large capacitor. The likely failure mode for the sensor is open circuit. The sensor test element 1246 comprises a series capacitor resistor arrangement C16, R31, arranged for testing this condition. In operation to test for an open circuit failure mode, a pulse is applied to capacitor C16 and the resulting voltage output from the current to voltage converter element 1244 is monitored.

The visual display portion 1250 is similar in configuration and operation to the visual display circuit 400 and will not be described again.

The circuit 1200 is further provided with a secondary memory element 1260 (not shown on FIG. 19) which supplements the internal memory of the microcontroller, this is particularly beneficial where the controller 1100 is used for integrated voice and alarm signals, especially for additional voice messages, for example, to provide for messages in a second language.

The microcontroller 1100 (not shown on FIG. 19) comprises a chip configured to provide both voice message signals and alarm signals to driver portion 1040. The internal memory of the microcontroller 1100 includes a plurality of pre-recorded voice messages. The microcontroller 1100 is also configured for the control and monitoring functionality required for the rest of the alarm circuit, including the step-up supply.

The above described alarm has the following advantages:
1 An alarm incorporates a set of adaptors enabling it to be either connected between a light fitting and a bulb, or directly in to a power adapter.
2 The alarm adaptor also has a second power outlet socket giving the user the benefit of not having to lose a power outlet.
3 The alarm can be connected between a fitting and a bulb, but with the main electronic module physically offset to one side to fit in to a wide variety of different lampshade fittings. This configuration has the thermal isolation and insulation properties of PCT/GB99/03326 while overcoming the limitations of a number of table and standard lamp shade designs in which the original invention would not fit.
4 A reflective surface finish is provided on the side of the alarm facing the light fitting to minimise radiated heat absorption, with a consequent improvement in battery and electronics lifetime.
5 Voice messages are provided to clarify the operation of the alarm when fitted in a light fitting covered by a shade as an LED or LCD display or readout would be obscured.
6 A rechargeable battery supply is used to enable powering of the alarms electronics when the power is switched off.
7 An automatic disabling facility is provided for transporting purposes that physically prevents connection to a light fitting or power outlet, or prevents the alarm being mounted in its normal standalone position.
8 The alarm has a mode of testing with real source of CO via a special docking station.
9 The use of a programmable IC to monitor battery levels to only switch on the battery charger when necessary to prevent unnecessary charging of the battery pack, which would reduce the life.
10 The use of a programmable IC (possibly the same as in 9 above) to modify the sensor sampling when the power to the lamp is switch off to maximise the operating time between periods of the light being energised.

1-30. (canceled)

31. An adaptor for an alarm comprising:
a first connector configured to electrically connect the adaptor to a source of mains electricity;
a second connector configured for onward electrical connection to the alarm;
wherein the adaptor is configured to fixedly support the alarm relative to the source of mains electricity.

32. An adaptor as claimed in claim 31, wherein
the first connector is configured to electrically connect the adaptor to a source of mains electricity that includes a light fitting.

33. An adaptor as claimed in claim 31, further comprising:
a third connector configured for onward electrical connection to a further electrical device.

34. An adaptor as claimed in claim 33, wherein the third connector includes an electrical socket.

35. An adaptor as claimed in claim 33, wherein the third connector is configured for onward connection to a light source.

36. An adaptor as claimed in claim 35, wherein the first connector includes a bayonet plug connector configured to connect to a bayonet socket of a light fitting and the third connector includes a bayonet socket configured to receive a bayonet-connector of a light source.

37. An adaptor as claimed in claim 35, wherein the first connector includes a screw plug connector configured to connect to a screw socket of a light fitting and the third connector includes a screw socket configured to receive a screw-connector of a light source

38. An adaptor as claimed in claim 31, wherein the alarm includes a housing and the adaptor is further configured to support the housing in a position laterally spaced from the mains power source.

39. Alarm apparatus for detecting radiation and/or pollutants, comprising:
a housing configured to house an alarm circuit, the alarm circuit including a detector configured to detect the radiation and/or pollutants, an alert device configured to alert a user of the presence of radiation and/or pollutant, and a controller configured to control the alarm circuit; and
an adaptor in configured to supply electric power to the alarm circuit, the adaptor including:
a first connector configured to electrically connect the adaptor to a source of mains electricity;
a second connector configured for onward electrical connection to the alarm;
wherein the adaptor is configured to fixedly support the alarm relative to the source of mains electricity.

40. Alarm apparatus as claimed in claim 39, wherein the adaptor and the housing are integral.

41. Alarm apparatus as claimed in claim 39, wherein the adaptor and the housing are discrete elements, the housing having an alarm connector configured for mutual engagement with the second connector of the adaptor to allow electrical connection of the circuit to the source of mains electricity.

42. Alarm apparatus as claimed in claim 39, wherein the alert device comprises an audible alert device configured to generate an audible alarm on detection of the radiation and/or pollutants.

43. Alarm apparatus as claimed in claim 42, wherein the audible alarm is a non-voice alarm signal, and wherein the audible alert device further includes a status providing device configured to provide status and/or alert information in the form of a voice message.

44. Alarm apparatus as claimed in claim 43, further comprising a separate voice chip that is configured to store and to control the voice messages.

45. Alarm apparatus as claimed in claim 43, wherein the controller comprises a controller chip, and wherein the voice messages are controlled by and stored on the control chip.

46. Alarm apparatus as claimed in claim 39, wherein the alarm circuit comprises an audio output configured to output both the audible alarm and the voice messages from a single speaker.

47. Alarm apparatus as claimed in claim 46, wherein the audible alarm and/or the voice messages are derived from audio signals, and wherein the audio output comprises an amplifier for increasing a magnitude of the audio signals for increased audio volume of from the single speaker.

48. Alarm apparatus as claimed in claim 47, wherein the amplifier includes a power amplifier.

49. Alarm apparatus as claimed in claim 48, further comprising a step-up power supply, the step-up power supply being configured to power the power amplifier.

50. Alarm apparatus as claimed in claim 43, wherein the alarm circuit includes an audio output configured to output both the audible alarm and the voice messages from a single speaker without a transformer.

51. Alarm apparatus as claimed in claim 39, wherein the alert device includes a visual alert indicator.

52. Alarm apparatus as claimed in claim 39, wherein the alarm circuit includes a rechargeable battery configured to allow a continuous supply of power to the alarm circuit when the source of mains electricity is absent.

53. Alarm apparatus as claimed in claim 52, wherein the alarm circuit includes a charging circuit to recharge the battery from the mains supply when the mains supply is electrically connected via the adaptor to the alarm circuit.

54. Alarm apparatus as claimed in claim 53, wherein the charging circuit includes a non-inductive step-down power supply.

55. Alarm apparatus as claimed in claim 53, wherein the alarm circuit includes a detector for detecting the charge level of the battery and wherein the controller is configured to monitor the charge level and to only allow recharging of the battery when the charge level falls below a predetermined level.

56. Alarm apparatus as claimed in claim 39, wherein the detector includes a sensor for sensing the radiation and/or pollutant.

57. Alarm apparatus as claimed in claim 56, wherein the sensor includes a semiconductor sensor.

58. Alarm apparatus as claimed in claim 56, wherein the sensor includes an electrochemical sensor.

59. Alarm apparatus as claimed in claim 57, wherein the alarm circuit is configured to sample the sensor at a sample rate controlled by the controller and wherein the controller is configured to sample at a lower rate when the alarm circuit is not electrically connected to the source of mains electricity.

60. Alarm apparatus as claimed in claim 59, wherein the alarm circuit is configured to manually induce an increased sampling rate for rapid sensing of the radiation and/or pollutant.
